(19) United States
(12) Patent Application Publication
(10) Pub. No.: US 2025/0141962 A1
(43) Pub. Date: May 1, 2025

(54) AUTOMATED METER READING THROUGH A FIXED-WIRE TELECOMMUNICATIONS NETWORK

(71) Applicant: CIG GrowthCo, LLC, The Woodlands, TX (US)

(72) Inventors: Jason Palmenberg, The Woodlands, TX (US); Yuxin Dai, Santa Rosa, CA (US)

(21) Appl. No.: 18/498,327

(22) Filed: Oct. 31, 2023

(51) Int. Cl. H04L 67/12; G16Y 20/30; G16Y 40/10; H04L 12/66

(52) U.S. Cl. CPC H04L 67/12; H04L 12/66; G16Y 20/30; G16Y 40/10

(57) ABSTRACT

An IoT (Internet of Things) gateway includes a data framing module including an input for receiving serial data from a utility meter and an output for sending application layer protocol frames to a network gateway, wherein the data framing module is configured to include the serial data in the application layer protocol frames selected from hyper-text transfer protocol frames, WebSocket protocol frames, TCP frames, and UDP frames. The IoT gateway may include a radio frequency receiver for receiving utility meter usage data transmitted by a utility meter according to one or more existing IoT protocols such as SCM/SCM+, LoRa, NB-IoT. In some options, a network gateway may be integrated with the IoT gateway to provide a single device. The IoT gateway and network gateway may be implemented in a system including the utility meter, a wide area network and an application server or data storage system.

### BACKGROUND

The present disclosure relates to the Internet of Things (“IoT”), automated utility meter reading and telecommunication networks.

### BACKGROUND OF THE RELATED ART

Utilities such as electrical power, natural gas and water are typically distributed from large, centralized sources to individual utility consumers over a wide area. A utility meter is located at the point of consumption for each utility consumer, such as an individual residence or business. A utility system will include many such utility meters that operate independently of each other utility meter. To monitor the amount of a utility consumed by each utility consumer, each utility meter must output utility meter data and the utility system must collect the utility meter data output by each utility meter.

For example, one widely used utility meter reading method/system defined as “legacy system” here, may employ a semi-automated system. The legacy system includes individual utility meters that generate meter data, including meter ID, date, time and amounts of utility consumption. The utility meter packs the meter data into data frames, then transmits the data frames via radio frequencies, for example, ranging from 908 MHz to 928 MHz. A mobile hand-held or vehicle-based meter data collection device must be physically moved around the utility system so that the data collection device is briefly located within the signal range of each utility meter's transmitter. When the mobile data collection device is within range of an individual utility meter, the meter data from that individual utility meter is automatically recorded by the mobile data collection device. If meter data from a particular utility meter is missing from the collected data set, the mobile collection device must make another trip to the location of that particular utility meter. Because significant effort is necessary to collect meter data from every utility meter, meter data is typically collected no more than once a month.

Other utility meter reading methods/systems use an automated system using a private network based on LoRa. LoRa (which gets its name from the term “long range” radio) is a low power consumption local private area network that is used to collect meter data from LoRa utility meters. A LoRa utility meter will transmit radio frequency signals over a distance of up to 2-5 kilometers to a LoRa gateway. The LoRa gateways retransmit the meter data over a private LPWAN (Low Power Wide Area Network) to a server.

Yet another method/system for reading utility meters is known as NB-IoT (Narrow Band Internet of Things). It uses public 4G wireless networks to transport utility meter data. Accordingly, the NB-IoT network consists of NB-IoT terminals (utility meters), NB-IoT base stations that communicate with each of the individual NB-IoT terminals via 4G wireless links, a 4G core network and NB-IoT servers in the cloud that collect the meter data.

### BRIEF SUMMARY

Some embodiments provide an IoT (Internet of Things) gateway comprising a data framing module including an input for receiving, via a serial data interface, the meter data frames from a utility meter through a radio link and an output for sending application layer protocol frames to a network gateway, wherein the data framing module is configured to embed the meter data frames in the application layer protocol frames, for example hyper-text transfer protocol frames, WebSocket protocol frames, TCP frames, or UDP frames, etc.

Some embodiments provide a system comprising a utility meter including a sensor for measuring utility usage and a transmitter for transmitting utility usage data. The system further comprises an IoT gateway including a data framing module for receiving the utility usage data and outputting an application layer protocol frame containing the utility usage data and a destination address for an application server or data storage system, wherein the application layer protocol frame such as a hyper-text transfer protocol frame, a WebSocket protocol frame, a TCP frame or a UDP frame is decoded. Still further, the system comprises a network gateway in communication with the IoT gateway for receiving the application layer protocol frame from the IoT gateway and forwarding the application layer protocol frame to the application server or data storage system over a wide area network.

Some embodiments provide a method of handling utility usage data. The method comprises receiving a radio frequency signal from a utility meter, wherein the radio frequency signal includes a utility meter data frame including an amount of utility usage measured by the utility meter, and demodulating the radio frequency signal to obtain the utility meter data frame. The method may further comprise mapping the utility meter data frame into an Internet Protocol packet, mapping the Internet Protocol packet into an application layer protocol frame, for example, a Hypertext Transfer Protocol frame, a WebSocket frame, a TCP frame, or a UDP frame, etc., and sending the application layer protocol frame to a network gateway for forwarding to an application server or data storage system over a wide area network.

Some embodiments provide a method of detecting a leaking utility. The method comprises a residential network gateway receiving a utility usage amount from a utility meter, the residential network gateway forwarding the utility usage amount over a public fixed wire network using technologies such as a Passive Optical Network (PON), Hybrid Fiber-Coaxial (HFC) network, or any digital subscriber line (XDSL) technology for data transportation, to a processing computer located at a data collection point, and the processing computer determining whether the utility usage amount is greater than a standard deviation threshold above utility usage amounts received from the utility meter during one or more historical periods and/or utility usage amounts received from one or more other utility meters during a current period. The method may further comprise the processing computer generating a service notification in response to determining that the utility usage amount is greater than a standard deviation threshold above the utility usage amounts received from the utility meter during one or more historical periods and/or the utility usage amounts received from the one or more other utility meters during a current period.

### BRIEF DESCRIPTION OF THE SEVERAL VIEWS OF THE DRAWINGS

FIG. 1 is a diagram of a system that supports automated utility meter reading and communication over a telecommunications network.

FIG. 2 is a diagram of a system with the broadband network implemented as a passive optical fiber network (PON) for example purposes.

FIG. 3 is a diagram a system including an integrated broadband home network gateway/IoT gateway.

FIG. 4 is a diagram of the components of an integrated network gate/IoT gateway for sending an HTTP frame to a wide area network.

FIG. 5 is a diagram of an integrated network gateway/IoT gateway that forms a WebSocket connection for sending utility usage data.

FIG. 6 is a diagram of an IoT gateway connected to an external broadband home network gateway for sending an HTTP frame to a wide area network.

FIG. 7 is a diagram of an IoT gateway connected to an external broadband home network gateway using a WebSocket connection.

### DETAILED DESCRIPTION

Some embodiments provide an IoT (Internet of Things) gateway comprising a data framing module including an input for receiving data frames from a utility meter via a serial port and an output for sending application layer protocol frames to a network gateway, wherein the data framing module is configured to embed the meter data frames in the application layer protocol frames such as hyper-text transfer protocol frames, WebSocket protocol frames, TCP frames and/or UDP frames.

The Internet of Things (IoT) describes devices with sensors, processing ability, software/firmware and/or other technologies that connect and exchange data with other devices and systems over a wide area network (such as the Internet) or other communications networks, such as a virtual private network (VPN). An individual IoT device may have one or more sensors, a processor and software and/or firmware executable by the processor. The individual IoT device may also include additional components, such as network interfaces or signal transceivers, without limitation. Furthermore, the processor and software and/or firmware may be replaced or supplemented with an application-specific integrated circuit (ASIC), a field-programmable gate array (FPGA) or a system-on-chip (SoC).

An individual IoT device, such as a utility meter, may have any or more sensor types as required by a particular application. For example, the one or more sensor types may be selected from a proximity sensor, accelerometer, motion detector, photoelectric sensor, capacitive sensor, thermistor, temperature sensors, gyroscope, image sensor, smoke detector, hall effect sensor, thermocouple, infrared sensor, ultrasound sensor, magnetism sensor, acoustic sensor, level sensor, gas detector, pressure sensor, humidity sensors, accelerometers, and flow sensors/meters. In addition to one or more sensor, the IoT device or utility meter may have a sampling and data processing unit, a transmitter unit, and a power source or connection to a power source.

An Internet of things (IoT) gateway provides the bridge (protocol converter) between one or more IoT devices in the field, one or more other devices on a wide area network (WAN) or in a cloud, and perhaps servers and user equipment such as a smartphone. The IoT gateway provides a communication link between one or more IoT devices in the field and one or more devices in a WAN or cloud and may provide real-time control of the one or more IoT devices in the field. Optionally, the IoT gateway may provide a communication link between one or more IoT devices in the field and one or more devices in a local area network (LAN), such as a home network gateway, in addition to one or more devices in a WAN or cloud. Without limitation, the one or more devices in the WAN, cloud or LAN may be one or more computers, such as one or more servers, one or more cluster of servers, or one or more cloud.

The data framing module is configured to embed the meter data frames (serial data) into the application layer protocol frames such as hyper-text transfer protocol frames, WebSocket protocol frames, TCP frames and UDP frames. Accordingly, the data framing module preferably has at least one serial port for receiving the meter data frames and at least one Ethernet port or internal bus for transmitting the application layer protocol frames. In some embodiments, the data framing module may be an application specific integrated circuit (ASIC) that is programmed to perform the operations needed to embed the serial data (meter data frames) into the application layer protocol frames. Optionally, the data framing module may convert serial data frames into HTTP/UDP (Hypertext Transfer Protocol/User Datagram Protocol) frames. The data framing module may cause a destination address to be included in the application layer protocol frames. For example, the destination address may identify an application server or a data storage system that is accessible via the wide area network.

The Hypertext Transfer Protocol (HTTP) is an application layer protocol in the Internet protocol suite model for distributed, collaborative, hypermedia information systems. The User Datagram Protocol (UDP) is one of the core communication protocols of the Internet protocol suite used to send messages (transported as datagrams in packets) to other hosts on an Internet Protocol (IP) network. WebSocket is a computer communications protocol, providing persistent full-duplex communication channels over a single Transmission Control Protocol (TCP) connection. TCP is one of the main protocols of the Internet protocol suite and provides reliable, ordered, and error-checked delivery of a stream of octets (bytes) between applications running on hosts communicating via an IP network.

A network gateway, which may be a broadband home network gateway, is a unit of networking hardware and/or software that allows data to be communicated between one discrete network and another discrete network. For example, a residence or business may have a network gateway that separates their local area network (LAN) from a wide area network (WAN), such as the Internet or broadband access network. Furthermore, the network gateway may be combined with router and/or modem functionality in separate devices or one single device, sometimes referred to as a residential gateway.

In some embodiments, the utility meters cause their utility usage (consumption) data and a utility meter identifier, and perhaps also a data and time, to be transmitted (i.e., “bubble up”) within the specified radio frequency spectrum with a proprietary data frame called SCM/SCM+ (Standard Consumption Message/Standard Consumption Message Plus). For example, a utility meter may send a data frame using SCM/SCM+ that includes some or all the following: date, time, communication protocol (SCM, SCM+, Interval Data Message (IDM), Net Meter IDM, R900 (Neptune meters), R900bcd (Neptune R900 using binary-coded digits), meter ERT ID (“Endpoint ID or ID), Consumption, Endpoint Type which is a code for the meter make type, ProtocolID which is a code for the broadcasting method being used, tamper codes, and packet CRC value. The “bubble up” communication or transmission of utility usage data can occur periodically, such as at a every 15, 30, or 60 seconds to 5 minutes depending on a utility meter communication setting used by the utility meter. This communication setting may be established and/or modified within the utility meter through an interface using the encoder receiver transmitter (ERT) protocol. The IoT gateway will then receive the radio signal or other transmission from the utility meter as often as a message “bubbles up” and is transmitted. However, interference from other nearby utility meters “bubbling up” at the same time on the same frequency or from other natural occurrences may or may not prevent a particular transmission of utility usage data to be received or accurately read by the IoT gateway. Fortunately, outside sources of interference are limited when the IoT gateway is deployed at the same location (i.e., home, business, property) as the utility meter due to the stronger signals and closer proximity of the transmitter (utility meter) and the receiver (IoT gateway).

In some scenarios an IoT gateway may receive data from multiple neighboring meters in close proximity depending on the radio receiver sensitivity Still, multiple utility meters in the same general area could “bubble up” at the same time on the same frequency and be received by any given IoT gateway depending on the localized IoT gateway placement. Worst case scenario is the utility meters which encountered interference from being on the same frequency at the same time during the original bubble-up will eventually be read by the IoT gateway as they randomly jump frequencies across the spread spectrum and re-transmit at a randomly chosen time. Once the IoT gateway collects and passes the utility usage data to an application server, data storage system or other computer system, the application server, data storage system or other computer system may then process the utility usage data and determine how to handle the data. For example, if the received utility usage data is from a single utility meter associated with an account or entity that is being serviced by the application server, then the application server or other computer system may store the utility usage data in association with the account or entity. If the received utility usage data is from multiple utility meters associated with multiple accounts or entities being serviced by the application server, then the application server or other computer system may store the utility usage data in association with corresponding accounts or entities. Furthermore, if the application server, data storage system or other computer system receives utility usage data from one or more utility meters that are not associated with an account or entity being serviced by the application server, then the utility usage data may be discarded. It is also possible that first and second IoT gateways in close proximity (i.e., in the same neighborhood) may each receive the radio signals containing utility usage data from first and second utility meters, where the first IoT gateway and first utility meter are on a first property and where the second IoT gateway and the second utility meter are on a second property. Since each transmission of utility usage data also includes a utility meter identifier and a time stamp, the application server or other computer system will recognize the redundant utility usage data. After verifying that any given utility usage data is redundant to utility usage data already received, the redundant data may be discarded.

In some embodiments, the IoT gateway may further comprise the broadband home network gateway, wherein the broadband home network gateway is connected to the output of the data framing module and includes an uplink port for communication over a wide area network. Accordingly, the device may be an integrated network gateway/IoT gateway device. Having both the network gateway and the IoT gateway in a single device may be both convenient and eliminate some cable connections, but an integrated network gateway/IoT gateway device may make efficient use of a single central processing unit (CPU) with sufficient processing power, memory resources, and capability for control of both the network gateway and the IoT gateway device, such as providing clock and synchronization, memory and buffer management, scheduling, and I/O management. In some options, the integrated network gateway/IoT gateway device may implement the network gateway and the IoT gateway on a single PCB (printed circuit board) or connected printed circuit boards within a single housing.

In some embodiments, the IoT gateway may further include, or have a port for connection with an internet service provider's access network device, such as an optical network terminal (ONT), DSL modem, cable modem, etc., depending on the type of access network technology used by the service provider Accordingly, the access network terminal may be connected to any type of public fixed broadband access network, such as a Passive Optical Network (PON), Hybrid Fiber-Coaxial (HFC) network, or any digital subscriber line (XDSL) technology for data transportation.

In some embodiments, the network gateway providing the broadband Internet access may also provide various IPTV services and/or telephone service. For example, an integrated broadband network gateway/IoT gateway may have all the broadband home network gateway functions, such as supporting “triple-play” (typically broadband Internet access, IPTV and telephone), and may serve as a unified IoT gateway supporting various IoT protocols. In a further option, the home gateway and/or the IoT gateway may also have wireless networking (Wi-Fi) capabilities, such as Wi-Fi for connecting the IoT devices and/or computing devices on a local area network (LAN).

In some embodiments, the IoT gateway may further include a radio-frequency wireless receiver tuned to receive one or more radio-frequency signal containing the serial data from the utility meter and/or other IoT device. The radio-frequency receiver may be connected to the input of the data framing module (i.e., a serial port) and may provide the serial data from the utility meter to the data framing module. The IoT gateway may include any number of one or more receivers that support (A) RF radio, (B) LoRa, and/or (C) NB-IoT, such that any of these meter/device types can be “read” wirelessly by the IoT gateway. Because there is a large installed base of utility meters that utilize these various communications methods, the IoT gateway may be able to read any or all of these types of communications. Furthermore, the IoT gateway may include a Wi-Fi receiver and/or a wired port for communication with the utility meter or other IoT device. However, shifting the entire utility monitoring system to a new utility meter would involve a huge and potentially disruptive roll-out. Rather, embodiments of the IoT gateway are preferably compatible with the large installed base of various legacy utility meters by including the capability to handle one or more of these legacy data transfer and communication methods or protocols. Specifically, a system including the IoT gateway may be backward compatible with various types of utility meters and other IoT devices, such as large installed legacy AMR (Automated Meter Reading) utility meters in North America, such as Itron AMR. It is a technical and/or technological benefit to have an IoT gateway on site with the utility meter to capture these wireless signals and forward them over one or more fixed broadband telecommunications networks.

In some embodiments, the utility meter measures an amount of utility usage and the serial data contained in the radio-frequency signal includes the amount of utility usage. The radio frequency wireless receiver may be tuned to receive predetermined ranges of radio frequency spectrums that are used by the transmitter of the utility meter. Optionally, the radio frequency wireless receiver of the IoT gateway may be configured to receive spread spectrum radio signals. In some specific examples, the radio frequency wireless receiver may be configured to receive LoRa data frames transmitted by a LoRa utility meter, data frames transmitted by a legacy utility meter, and/or utility meter data using a wireless 4G mobile protocol (such as NB-IoT). Furthermore, the IoT gateway may include one or more radio frequency wireless receivers configured to receive a first radio-frequency signal transmitted by a LoRa utility meter, a second radio-frequency signal transmitted by a second legacy utility meter, and/or a third NB-IoT utility meter using a wireless 4G mobile protocol/Wi-Fi. The IoT gateway and/or an integrated network gateway/IoT gateway are preferably compatible with existing or future home networking devices, architecture and protocols for data collection.

In some embodiments, the IoT gateway may further comprise one or more networking ports for wired communication with at least one IoT device other than the utility meter. The wired networking ports may be Ethernet ports and such Ethernet ports may incorporate Power over Ethernet (POE) to provide electrical power to the utility meter through an Ethernet cable. In a further option, the IoT gateway may include a battery back-up providing emergency power to the IoT gateway and perhaps also to the utility meter via the Power over Ethernet.

Some embodiments provide a system comprising a utility meter including a sensor for measuring utility usage and a transmitter for transmitting utility usage data. The system further comprises an IoT gateway including a data framing module for receiving the utility usage data and outputting an application layer protocol frame containing the utility usage data and a destination address for an application server or data storage system, wherein the application layer protocol frame is selected from a hyper-text transfer protocol frame, a WebSocket protocol frame a TCP frame and a UDP frame. Still further, the system comprises a network gateway in communication with the IoT gateway for receiving the application layer protocol frame from the IoT gateway and forwarding the application layer protocol frame to the application server or data storage system over a wide area network.

In some embodiments, the system may include any one or more aspects of the IoT gateway, network gateway, and/or radio frequency receiver disclosed above in reference to the IoT gateway embodiments. As a non-limiting example, the utility meter transmitter may be a radio frequency transmitter for transmitting a radio frequency signal containing the utility usage data, the IoT gateway may include a radio frequency receiver tuned to receive the radio-frequency signal from the utility meter transmitter, and the radio frequency receiver may provide the utility usage data to the IoT gateway. Furthermore, the radio frequency transmitter may be a spread spectrum transmitter and the radio frequency receiver may be a spread spectrum receiver. In one option, the utility meter may form a data frame containing the utility usage data and may transmit the data frame in the radio frequency signal, wherein the radio frequency receiver may receive the radio frequency signal and provide the utility usage data to the data framing module. In another option, the radio frequency transmitter of the utility meter may be a LoRa transmitter and the radio frequency receiver of the IoT gateway may be tuned to receive LoRa data frames transmitted by the LoRa transmitter. The data framing module may include a serial port for receiving the serial data stream from the radio-frequency receiver.

In some embodiments, the system further comprises a central processing unit, wherein the network gateway is integrated with the IoT gateway and the central processing unit provides a clock signal to the data framing module, the radio frequency receiver and the network gateway.

In some embodiments, the system may further comprise an optical network transmitter that communicates with the network gateway for sending the application layer protocol frame over a passive optical network to a collection point for forwarding to the application server or data storage system over the wide area network. The passive optical network may include a plurality of Optical Line Terminals (OLTs) wherein each OLT connects with an optical fiber that is split passively to connect with a plurality of ONTs (Optical Network Terminal), and each ONT may connect to a home network gateway. For example, each of the plurality of optical fibers may be split and connected to between 8 and 32 ONTs. In one option, the home network gateway may forward the application layer protocol frame to the application server, wherein the application server may be an Internet-of-Things server, broadband billing server and/or utility billing server.

In some embodiments of the system, the utility meter may transmit the utility usage data to the IoT gateway using an IoT protocol, for example the LoRa protocol, Narrow Band Internet of Things protocol (NB-IoT), Standard Consumption Message protocol, or Standard Consumption Message Plus protocol, etc. Optionally, the network gateway may be in communication with the IoT gateway over an Ethernet connection or a Wi-Fi connection.

Some embodiments provide a method of handling utility usage data. The method comprises receiving a radio frequency signal from a utility meter, wherein the radio frequency signal includes a utility meter data frame including an amount of utility usage measured by the utility meter and demodulating the radio frequency signal to obtain the utility meter data frame. The method may further comprise mapping the utility meter data frame into an Internet Protocol packet, mapping the Internet Protocol packet into an application layer protocol frame selected from a Hypertext Transfer Protocol frame, WebSocket frame, a TCP frame and a UDP frame and sending the application layer protocol frame to a network gateway for forwarding to an application server or data storage system over a wide area network.

In some embodiments, the method of handling utility usage data may include any one or more aspects or uses of the utility meter, IoT gateway, network gateway, radio frequency receiver, data framing module, broadband network, application server and/or data storage system disclosed above in reference to the IoT gateway embodiments and/or system embodiments.

In some embodiments, the method may further comprise analyzing the amount of utility usage to identify a utility usage rate and determining whether the utility usage rate indicates that there is a leak within a utility monitored by the utility meter, degradation of flow within the utility monitored by the utility meter, and/or failure of the utility meter.

In some embodiments, the utility meter data frame may be encrypted by the utility meter or the data framing module, and the application layer protocol frame may include the encrypted utility meter data or data frame. Optionally, the network gateway may forward the application layer protocol frame over a fixed-wire telecommunications network to a local network demarcation or collection point via wired network communications, such as Ethernet, and/or wireless network communications, such as Wi-Fi, while the utility meter data is maintained in an encrypted data format.

Some embodiments provide a method of detecting a leaking utility. The method comprises a residential network gateway receiving utility usage amount from a utility meter, the residential network gateway forwarding the utility usage amount over a public broadband network to a processing computer located at a data collection point, and the processing computer determining whether the utility usage amount is greater than one or more programmed thresholds, established by the software administrator, above utility usage amounts received from the utility meter during one or more historical periods and/or utility usage amounts received from one or more other utility meters during a current period. The method may further comprise the processing computer generating a service notification in response to determining that the utility usage amount is greater than a standard deviation threshold above the utility usage amounts received from the utility meter during one or more historical periods and/or the utility usage amounts received from the one or more other utility meters during a current period.

In some embodiments, the method of detecting a leaking utility may include any one or more aspects or uses of the utility meter, IoT gateway, network gateway, radio frequency receiver, data framing module, broadband network, application server and/or data storage system disclosed above in reference to the IoT gateway embodiments, the system embodiments and/or the method of handling utility usage data embodiments.

In some embodiments, the method of detecting a leaking utility may further comprise the processing computer determining a total utility usage amount for the utility meter over a period of time and the processing computer sending the total utility usage amount to an application server and/or data storage system.

In some embodiments of the method of detecting a leaking utility, the processing computer may compare the utility usage data to the historical utility usage data received from the utility meter during the same time of year and/or normalized to temperature versus consumption patterns.

In some embodiments of the method of detecting a leaking utility, the utility meter may be installed at a residence having one or more predetermined characteristics, wherein the processing computer compares the utility usage data to utility usage data received from one or more other utility meters that are installed at residences that also have the one or more predetermined characteristics. Optionally, the utility usage amount may be sent to the processing computer using a virtual local area network and/or the processing computer may forward public network communications that are not from the utility meter to a wide area network.

In some embodiments, the method of detecting a leaking utility may further comprise assigning a public IP address to the utility meter, the residential network gateway transmitting a public network communication including the utility usage amount and the public IP address from the network gateway to the processing computer on a dedicated virtual local area network connection, the processing computer directing the public network communication to a designated application server and/or data storage system, and the processing computer transmitting public network communications from the residential network gateway to a wide area network.

Some embodiments enable a utility meter to be read at any desired schedule or frequency that a meter owner desires, such as ranging from continuous readings to a user-defined schedule for reading the amount of utility usage from the utility meter. This capability for reading the meter at any desired schedule or frequency allows each meter owner to conduct real-time data analysis for leak detection, system flow degradation, or potential meter failure that existing systems cannot support. While the utility meter may be set to bubble up data at predetermined intervals, such as every 15, 30 or 60 seconds to 5 minutes, this data is not currently read but once a month for billing purposes due to the effort required to collect the data with a mobile reader. In one example, the utility usage data is read at a desired frequency and sent to the application server. The application server may then automatically analyze the usage data to detect a leak or other problems within the system. Alternatively, an individual user or meter owner may access the application server to initiate diagnostics.

Some embodiments enable the utility meter data, including the amount of utility usage measured by the utility meter, to traverse a fixed-wire telecommunications network from the individual utility meter to a local network demarcation point (e.g., a home network gateway) via wired network communications, such as Ethernet, and/or wireless network communications, such as Wi-Fi, while the meter data may be maintained in an optional encrypted data format.

In some embodiments, the utility meter and/or utility meter reading apparatus may be redesigned to take advantage of fixed-wire telecommunications network elements, thereby reducing an overall cost of the utility meter and the utility meter reading apparatus. For example, a utility meter may be redesigned so that the utility meter is connected to the broadband equipment suite, such as the utility meter using communication protocols that leverage Wi-Fi and/or CAT5/6 Ethernet connections for a hardwired connection from the utility meter to the home network gateway and/or the utility meter receiving electrical power directly from the home electrical system or power-over-ethernet (POE) while potentially leveraging power back-up systems typically deployed with home gateway devices.

In some embodiments, a utility meter that is directly connected with the IoT gateway via an Ethernet cable and/or Ethernet with Power Over Ethernet (POE, which combines data communication and a power source) may no longer require a radio chip and/or a battery. Wi-Fi and/or Ethernet facilitates direct data transmission from the utility meter to the IoT gateway and/or the network gateway or, in the case of a fiber network, to the optical network terminal without the limitations of radio frequency interference or timing constraints of bubble-up transmission settings. An additional beneficial result of a utility meter being connected to a home network gateway/IoT gateway via PoE is that the collection frequency of utility meter data is not constrained by battery life considerations.

In some embodiments, an integrated network gateway/IoT gateway that is a network client of a fixed-wire network and utilized by the utility meter, provides the opportunity for a new integrated broadband home network/IoT gateway design to capture and transport the associated utility meter data. In one example, if the utility meter has a fixed-wire connection to the network, such as a wired connection to the IoT gateway, then the consumer premise equipment (CPE), such as an ONT, of the fixed-wire network may include a battery back-up or other secondary power source that can provide emergency power to the utility meter via PoE. In another example, if the utility meter is a legacy RF-based utility meter, then the home gateway/router may be retrofitted or redesigned to work with or include an RF radio receiver to allow the home gateway/router to read the RF-based utility meter, which may operate with RF-spread spectrum.

Some embodiments described herein, including the method embodiments, may be partially or fully implemented as a computer program product including program instructions that, when executed by a processor, cause the processor to perform, implement or initiate any one or more aspects of the methods described herein. Furthermore, such program instructions may be stored as software or firmware to be executed by a separate processor, such as a central processing unit, or may be implemented in an application specific integrated circuit (ASIC), field-programmable gate array (FPGA) or system on a chip (SoC).

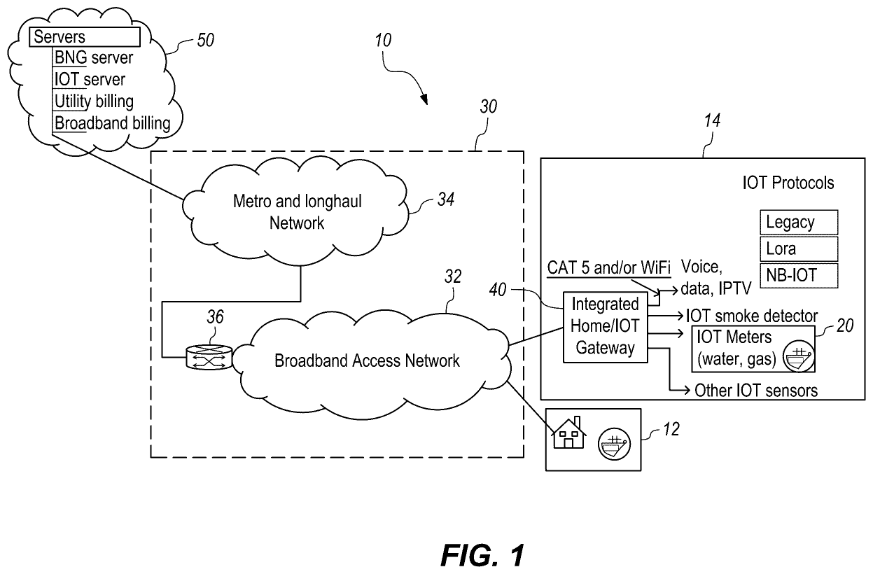

FIG. 1 is a diagram of a system 10 that supports automated reading of one or more utility meter 20 and communication of messages containing utility meter data over a telecommunications network 30. The one or more utility meters 20 may communicate with an IoT gateway, which may be a component of an integrated network gateway/IoT gateway device 40. For example, the one or more utility meters 20 and the integrated network gateway/IoT gateway device 40 may be installed at an individual residence (home) 14, business or other physical location, entity or building. The utility meter 20 at one location may measure an amount of utility usage or consumption and transmit messages or data frames including the amount of utility usage or consumption to the integrated network gateway/IoT gateway device 40 at the same location. Neighboring residences, businesses or other entities may have a similar utility meter and integrated network gateway/IoT gateway. One neighboring residence 12 is illustrated, but an unlimited number of residences or entity locations may be included.

The integrated network gateway/IoT gateway device 40 may also communicate with additional IoT devices at the residence 14. The additional IoT devices may differ from the one or more utility meters 20 by the type of IoT device and/or by the communication protocol used to communicate with the integrated network gateway/IoT gateway device 40. The additional IoT device types are not limited, but are illustrated as including an IoT smoke detector, and the communications protocols are not limited, but may include legacy protocols such as LoRa and NB-IoT. Still further, other IoT devices may communicate with the integrated network gateway/IoT gateway device 40 via a Category 5 (CAT 5) cable and/or a Wi-Fi wireless protocol connection.

The integrated network gateway/IoT gateway device 40 separates the local area network at the residence 14 from the telecommunications network 30, which may be or include a wide area network. The telecommunications network 30 is illustrated as including both a broadband access network 32 and a metro and long haul network 34 separated by a network switch and/or router 36. However, the telecommunications network 30 enables HTTP frames to be sent from the integrated network gateway/IoT gateway device 40 to one or more application servers or data storage systems 50. Non-limiting examples of an application server 50, include a broadband network gateway (BNG) server, IoT server, utility billing server and/or broadband billing server. The server(s) may be implemented in a cloud computing environment.

The end-to-end system may include the integrated broadband network gateway/IoT gateway 40 at a utility customer premise 14, broadband access network 32 and metro network 34, and cloud servers 50. For example, the broadband access network 32 may be used to transmit the utility meter data to a head-end of a service provider. From there, the utility meter data may need to be sent to other networks, which may or may not be built/controlled by the Internet Service Provider (ISP), so that the data can be sent to a datacenter/physical private servers/cloud/etc. 50 depending on where a utility provider may want to receive the utility meter data. The cloud servers 50 may include broadband network gateway (BNG) servers for broadband triple-play services; IoT servers that support various IoT protocols, such as Lora, NB-IoT, legacy SCM/SCM+, etc., for utility meter data; and/or customer billing servers for broadband and/or utilities. The broadband access network and metro network are public networks and the proposed IoT system may use these networks without modifications.

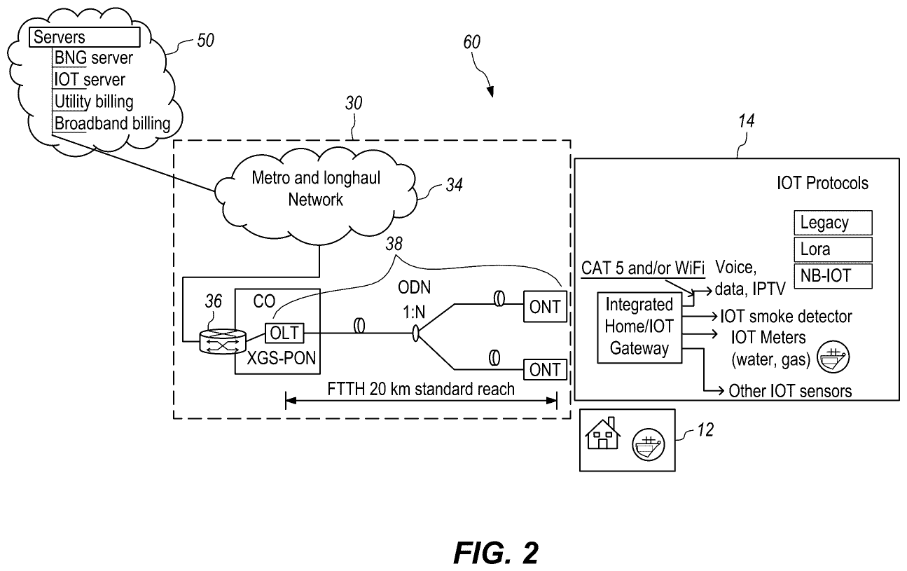

FIG. 2 is a diagram of a system 60 that is similar to the system 10 of FIG. 1 except that the broadband network 32 within the telecommunications network 30 has been specifically illustrated as an optical fiber network 38. For example, the optical fiber network 38 may be a passive optical network (PON) or fiber-to-the-home (FTTH) network. Accordingly, the integrated broadband network gateway/IoT gateway 40 may communicate over the PON FTTH network to a central office (CO), aka head-end, where the optical distribution network ends and transfers over to the metro/long-haul network 34.

An Optical Distribution Network (ODN) includes conduit, fiber, and splitters between the Optical Line Terminal (OLT) in the central office (CO) and the Optical Network Terminal (ONT). The optical distribution network split ratio (1: N) indicates that a single optical fiber can be split 1:8, 1:16: or 1:32 or more to support multiple homes on a single ODN. The OLT (Optical Line Terminal) communicates with 8, 16, 32, or more ONTs with Point-to-multiple Point protocols. Nonlimiting examples of the passive optical network (PON) includes XG-PON and G-PON.

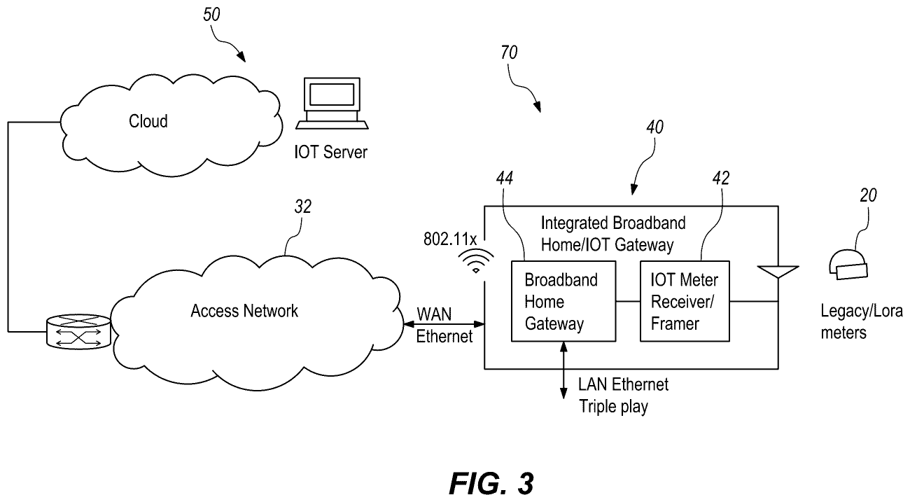

FIG. 3 is a diagram of a system 70 including an integrated home network gateway/IoT gateway 40. The integrated home network gateway/IoT gateway 40 includes an IoT meter receiver and data framer 42 for utility meter data collection and a broadband home network gateway 44. In the illustrated example, the home network gateway 44 may provide triple-play services, including broadband Internet access, television and telephone/voice. The Internet access may be distributed to other computing devices over a local area network (LAN) including wired Ethernet and/or wireless Wi-Fi connections. The wide area network (WAN) interface of the integrated broadband home/IoT gateway communicates with IoT servers in the cloud via fixed access networks.

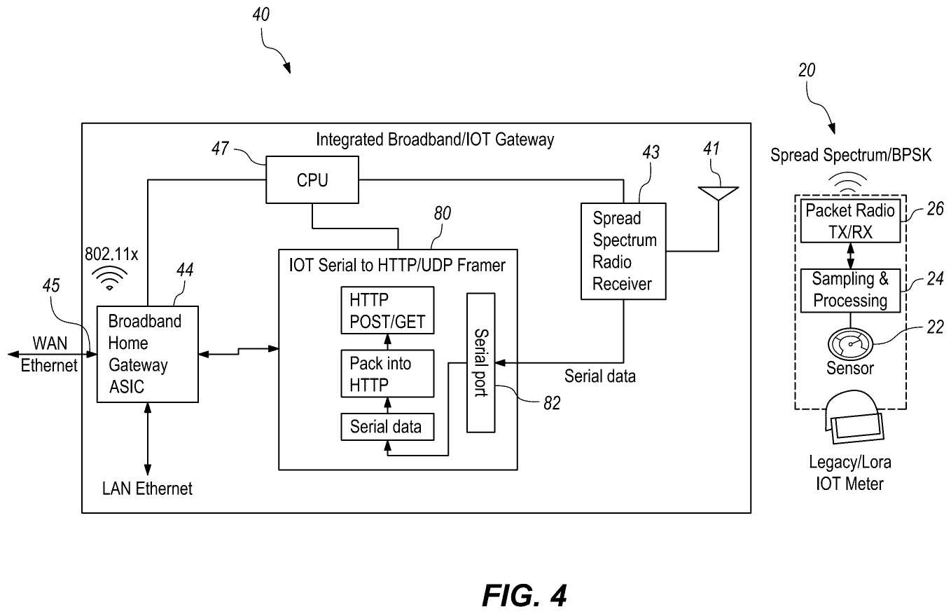

FIG. 4 is a diagram of the components of an integrated home network gateway/IoT gateway 40 and the components of a legacy utility meter 20, such as a LoRa utility meter or Itron automated meter reader (AMR). The utility meter 20 includes, without limitation, a sensor 22, a sampling and processing unit 24, and a packet radio transceiver 26. For example, the radio transceiver may transmit a spread spectrum signal, such as a binary phase shift keying (BPSK) signal.

The physical sensors 22 may converge the machinery rotation movements in the utility meters into a raw signal pulse. The sampling and data processing unit 24 calibrates the raw signal pulse from the sensor into utility usage or consumption data and further packs the data into “meter” frames. For example, the meter frames may consist of preambles, head, meter ID, customer ID, utility usage/consumption data and cyclic redundancy check (CRC). For legacy meters and LoRa meters, which are not Internet Protocol (IP) addressable, the meter data frames are directly transmitted by the transceiver 26. Legacy meters and LoRa meters are not IP addressable because the chipset included in the encoder receiver transmitters (ERTs) (for RF/Itron based meters) and LoRa meters are a closed network which does not require the use of IP addresses. The radio transmitter unit 26 may transmit the frames from the data processing unit 24 over spread spectrum radio links.

The IoT meter receiver/framer 42 of FIG. 3 is now shown as two separate components, namely an IoT Serial to HTTP/UDP Framer 80 and a spread spectrum radio receiver 43 coupled to an antenna 41. The spread spectrum radio receiver 43 on the Integrated Broadband/IoT Gateway receives the radio signal from the IoT meter transmitter 26 and demodulates the RF signal into serial data that consists of the utility meter data frame. In the case of an Itron meter, the serial data received by the radio receiver consists of Itron's SCM/SCM+ (Standard Consumption Message) meter data frames. The radio receiver unit 43 may be designed as a configurable sampling frequency controller to adapt to the needs of different applications. One example of an application that preferably has a higher sampling rate is gas leak detection.

The IoT processing unit (“IoT Serial to HTTP/UDP Framer”) 80 on the Integrated Broadband Home/IoT Gateway 40 receives the serial data from the spread spectrum radio receiver 43, where the serial data may that consists of utility meter data frames. The Framer 80 may then map the meter data frame (serial data) into IP packets. Accordingly, the Integrated broadband Home/IoT gateway 40 receives the meter data from the legacy meters and Lora meters 20 (which are not IP addressable) and places the meter data in a frame that is IP addressable. In one option, the Framer 80 further maps the IP frame that consists of the meter data into HTTP frames. The HTTP frames are then sent to the broadband home network gateway ASIC 44 for combining with other home data traffic so that any or all of home data traffic may be forwarded to the Wide Area Network (WAN) interface 45 for transmission onto the access network. For example, the WAN interface 45 of the Integrated Broadband/IoT Gateway 40 may connect to the Passive Optical Network (PON) (see FIG. 2) for communicating data to the Internet.

The IoT Serial to HTTP/UDP Framer 80 may be an ASIC that is programmed or configured to receive the utility meter data from the receiver 43 at the serial port 82 and perform the operations of placing the utility meter data into an IP addressable frame and into an HTTP frame before forwarding the HTTP frame to the broadband home gateway ASIC 44. A central processing unit (CPU) 47 is provided to coordinate the operations of the components 44, 80, 43, such as controlling clock and synchronization to support operation and communication between the components.

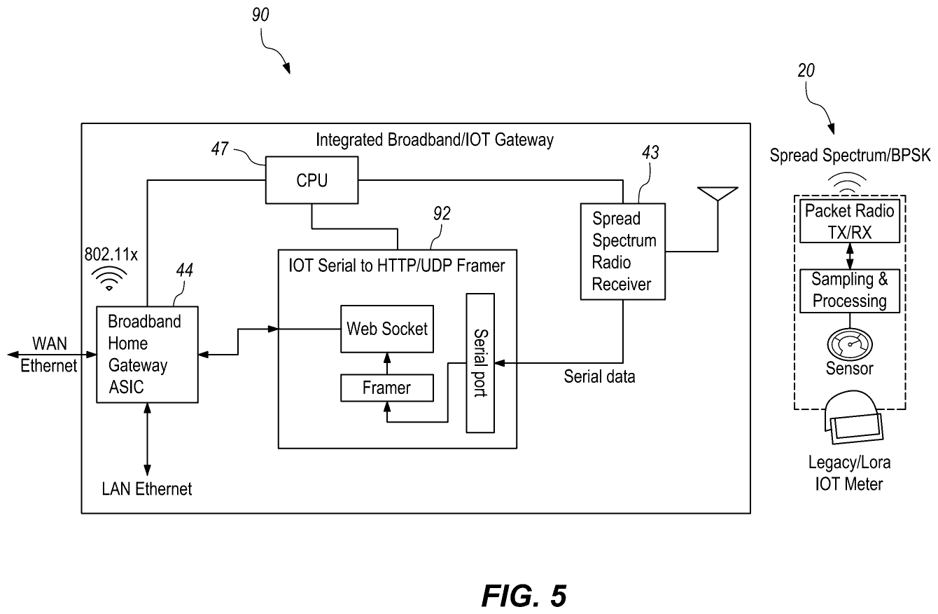

FIG. 5 is a diagram of an integrated network gateway/IoT gateway 90 that forms a WebSocket connection for sending utility usage data. The integrated network gateway/IoT gateway 90 is substantially similar to the gateway 40 that in FIG. 4, except that the Framer 92 forms a WebSocket protocol connection and communicates over the WebSocket. WebSocket is a computer communications protocol, providing full-duplex communication channels over a single TCP connection. Accordingly, the IoT processing unit 92 maps the IP frame that consists of the meter data into a web socket protocol message. The web socket is a permanent packet connection from broadband home/IoT gateway 90 to the IoT servers 50 (see FIGS. 1-3) in the cloud.

In some embodiments, the Integrated Broadband Home/IoT gateway 40, 90 may be implemented on any general-purpose network processing and control component, such as a Central Processing Unit (CPU) with sufficient processing power, memory resources, and capability to handle instruction execution, logical operations, hardware devices control, clock and synchronization, memory and buffer management, scheduling, and I/O management.

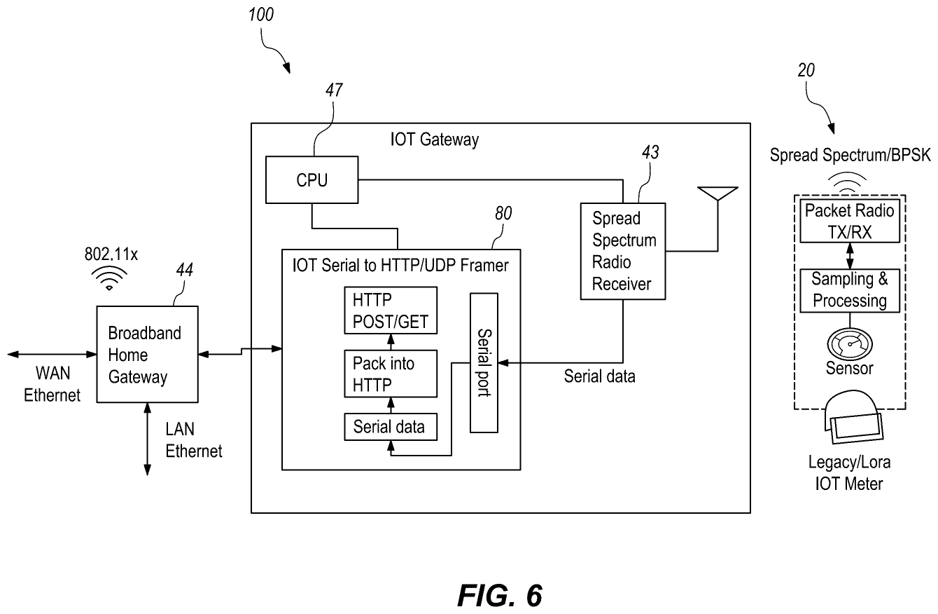

FIG. 6 is a diagram of an IoT gateway 100 connected to an external home network gateway 44 for sending an HTTP frame to a wide area network. The IoT gateway 100 operates in conjunction with the home network gateway 44 in the same manner as the integrated home network gateway/IoT gateway 40 in reference to FIG. 4, except that the home network gateway 44 is a separate component from (i.e., not integrated with) the IoT gateway. As a result, the home network gateway 44 will have its own central processing unit (CPU) (not shown).

Accordingly, the IoT gateway 100 is a standalone unit that may be connected to a broadband home gateway device 44 via Ethernet or Wi-Fi connections. The functions of the IoT gateway 100 may be the same as the IoT gateway portion of the integrated broadband/IoT home gateway 40 described in reference to FIG. 4.

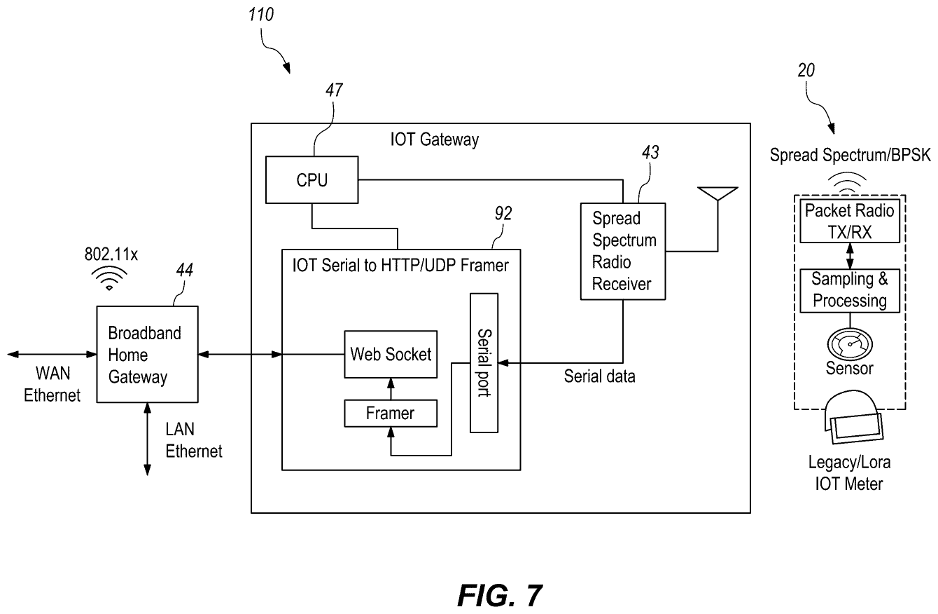

FIG. 7 is a diagram of an IoT gateway 110 connected to an external home network gateway 44 using a WebSocket connection. The IoT gateway 110 operates in conjunction with the home network gateway 44 in the same manner as the integrated network gateway/IoT gateway 90 in reference to FIG. 5, except that the home network gateway 44 is a separate component from (i.e., not integrated with) the IoT gateway. As a result, the network gateway 44 will have its own central processing unit (CPU) (not shown).

Accordingly, the IoT gateway 110 is a standalone unit that may be connected to a broadband home gateway device 44 via Ethernet or Wi-Fi connections. The functions of the IoT gateway 110 may be the same as the IoT gateway portion of the integrated broadband/IoT home gateway 90 described in reference to FIG. 5.

In some embodiments, the Integrated Broadband Home/IoT gateway 100, 110 may be implemented on any general-purpose network processing and control component, such as a Central Processing Unit (CPU) with sufficient processing power, memory resources, and capability to handle instruction execution, logical operations, hardware devices control, clock and synchronization, memory and buffer management, scheduling, and I/O management.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition, or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

1. An IoT gateway, comprising:
a data framing module including an input for receiving, via a serial data interface, meter data frames directly from a utility meter through a radio link and an output for sending application layer protocol frames to a network gateway, wherein the data framing module is configured to embed the meter data frames in the application layer protocol frames selected from hyper-text transfer protocol frames, WebSocket protocol frames, TCP frames and UDP frames.

2. The IoT gateway of claim 1, further comprising:
the network gateway, wherein the network gateway is connected to the output of the data framing module and includes an uplink port for communication over a wide area network.

3. The IoT gateway of claim 2, wherein the uplink port [for] is for connection to a public fixed wire network selected from a Passive Optical Network, Hybrid Fiber-Coaxial network, or digital subscriber line.

4. The IoT gateway of claim 2, wherein the network gateway provides broadband Internet access, IP-television service, and/or telephone service.

5. The IoT gateway of claim 1, further comprising:
a central processing unit controlling clock and synchronization, memory and buffer management, scheduling, and I/O management to the data framing module and the network gateway.

6. The IoT gateway of claim 1, further comprising:
a radio-frequency wireless receiver tuned to receive a radio-frequency signal containing serial data from the utility meter, wherein the radio-frequency receiver is connected to the input of the data framing module and provides the serial data from the utility meter to the data framing module.

7. The IoT gateway of claim 6, wherein the utility meter measures an amount of utility usage and the serial data contained in the radio-frequency signal includes the amount of utility usage.

8. The IoT gateway of claim 7, wherein the radio frequency wireless receiver is tuned to receive one or more predetermined radio frequencies.

9. The IoT gateway of claim 8, wherein the radio frequency wireless receiver is configured to receive spread spectrum radio signals.

10. The IoT gateway of claim 9, wherein the radio frequency wireless receiver is configured to receive LoRa data frames transmitted by a LoRa utility meter.

11. The IoT gateway of claim 6, wherein the radio frequency wireless receiver is configured to receive data frames transmitted by a utility meter using a wireless mobile telecommunications protocol.

12. The IoT gateway of claim 6, wherein the radio frequency wireless receiver is configured to receive a first radio-frequency signal transmitted by a LoRa utility meter and a second radio-frequency signal transmitted by a second utility meter using a wireless mobile telecommunications protocol.

13. The IoT gateway of claim 1, further comprising:
a wireless networking transceiver for wireless communication with at least one IoT device other than the utility meter.

14. The IoT gateway of claim 1, further comprising:
one or more networking ports for wired communication with at least one IoT device other than the utility meter.

15. The IoT gateway of claim 14, wherein the one or more networking ports are Ethernet ports providing Power over Ethernet to the utility meter.

16. The IoT gateway of claim 15, further comprising:
a battery back-up providing emergency power to the utility meter via the Power over Ethernet.

17. The IoT gateway of claim 1, further comprising:
a central processing unit controlling clock and synchronization, memory and buffer management, scheduling, and I/O management to the data framing module.

18. The IoT gateway of claim 1, wherein the data framing module causes a destination address to be included in the application layer protocol frames, wherein the destination address identifies an application server or a data storage system that is accessible via the wide area network.

19. A system comprising:
a utility meter including a sensor for measuring utility usage and a transmitter for transmitting utility usage data;
an IoT gateway including a data framing module for receiving the utility usage data directly from the utility meter and outputting an application layer protocol frame containing the utility usage data and a destination address for an application server or data storage system, wherein the application layer protocol frame is selected from a hyper-text transfer protocol frame, WebSocket protocol frame, TCP frame, and UDP frame; and
a network gateway in communication with the IoT gateway for receiving the application layer protocol frame from the IoT gateway and forwarding the application layer protocol frame to the application server or data storage system over a wide area network.

20. The system of claim 19, wherein the utility meter transmitter is a radio frequency transmitter for transmitting a radio frequency signal containing the utility usage data, wherein the IoT gateway includes a radio frequency receiver tuned to receive the radio-frequency signal from the utility meter transmitter, and wherein the radio frequency receiver provides the utility usage data to the IoT gateway.

21. The system of claim 20, wherein the radio frequency transmitter is a spread spectrum transmitter, and the radio frequency receiver is a spread spectrum receiver.

22. The system of claim 20, wherein the utility meter forms a data frame containing the utility usage data and transmits the data frame in the radio frequency signal, and wherein the radio frequency receiver receives the radio frequency signal and provides the utility usage data to the data framing module.

23. The system of claim 20, wherein the radio frequency transmitter of the utility meter is a LoRa transmitter, and wherein the radio frequency receiver of the IoT gateway is tuned to receive LoRa data frames transmitted by the LoRa transmitter.

24. The system of claim 20, wherein the data framing module includes a serial port for receiving a serial data stream from the radio-frequency receiver.

25. The system of claim 20, further comprising:
a central processing unit, wherein the network gateway is integrated with the IoT gateway and the central processing unit provides clock and synchronization, memory and buffer management, scheduling, and I/O management to the data framing module, the radio frequency receiver and the network gateway.

26. The system of claim 19, wherein the network gateway forwards the application layer protocol frame to the application server, wherein the application server is a broadband network gateway server, Internet-of-Things server, broadband billing server and/or utility billing server.

27. The system of claim 19, wherein the utility meter transmits the utility usage data using an IoT protocol selected from LoRa protocol, Narrow Band Internet of Things protocol, Standard Consumption Message protocol, and Standard Consumption Message Plus protocol.

28. The system of claim 19, wherein the network gateway is in communication with the IoT gateway over an Ethernet connection or a Wi-Fi connection.
